(19) United States
(12) Patent Application Publication
(10) Pub. No.: US 2021/0216887 A1
(43) Pub. Date: Jul. 15, 2021

(54) KNOWLEDGE GRAPH ALIGNMENT WITH ENTITY EXPANSION POLICY NETWORK

(71) Applicant: NEC Laboratories America, Inc., Princeton, NJ (US)

(72) Inventors: Wenchao Yu, Plainsboro, NJ (US); Wei Cheng, Princeton Junction, NJ (US); Haifeng Chen, West Windsor, NJ (US)

(21) Appl. No.: 17/147,035

(22) Filed: Jan. 12, 2021

Related U.S. Application Data
(60) Provisional application No. 62/960,728, filed on Jan. 14, 2020.

(51) Int. Cl. G06N 5/02; G06K 9/62; G06N 7/00; G06N 3/08

(52) U.S. Cl. CPC G06N 5/022; G06K 9/6262; G06K 9/6256; G06N 3/08; G06N 7/005

(57) ABSTRACT

A computer-implemented method is provided for cross-lingual knowledge graph alignment. The method includes formulating a credible aligned entity pair selection problem for cross-lingual knowledge graph alignment as a Markov decision problem having a state space, an action space, a state transition probability and a reward function. The method further includes calculating a reward for a language entity selection policy responsive to the reward function. The method also includes performing credible aligned entity selection by optimizing task-specific rewards from an alignment-oriented entity representation learning phrase. The method additionally includes providing selected entity pairs as augmented alignments to the representation learning phase.

### RELATED APPLICATION INFORMATION

This application claims priority to U.S. Provisional Patent Application No. 62/960,728, filed on Jan. 14, 2020, incorporated herein by reference in its entirety.

### BACKGROUND

### Technical Field

The present invention relates to graph processing and more particularly to knowledge graph alignment with entity expansion policy network.

### Description of the Related Art

Multilingual Knowledge Graphs (KGs) such as DBpedia include structured knowledge of entities in several distinct languages which are useful resources for cross-lingual Natural Language Processing (NLP) applications. Cross-lingual KG alignment is the task of matching entities with their counterparts in different languages, which is an important way to enrich the cross-lingual links in multilingual KGs. Existing KG alignment methods usually rely on prior entity alignment (i.e., the given aligned entities, which are only a small proportion compared with the entire entity pool) as training data. Limited prior entity alignment has shown to prevent the KG alignment approaches from learning accurate embeddings for entity alignment.

### SUMMARY

According to aspects of the present invention, a computer-implemented method is provided for cross-lingual knowledge graph alignment. The method includes formulating a credible aligned entity pair selection problem for cross-lingual knowledge graph alignment as a Markov decision problem having a state space, an action space, a state transition probability and a reward function. The method further includes calculating a reward for a language entity selection policy responsive to the reward function. The method also includes performing credible aligned entity selection by optimizing task-specific rewards from an alignment-oriented entity representation learning phrase. The method additionally includes providing selected entity pairs as augmented alignments to the representation learning phase.

According to other aspects of the present invention, a computer program product is provided for cross-lingual knowledge graph alignment. The computer program product includes a non-transitory computer readable storage medium having program instructions embodied therewith. The program instructions are executable by a computer to cause the computer to perform a method. The method includes formulating a credible aligned entity pair selection problem for cross-lingual knowledge graph alignment as a Markov decision problem having a state space, an action space, a state transition probability and a reward function. The method also includes calculating a reward for a language entity selection policy responsive to the reward function. The method further includes performing credible aligned entity selection by optimizing task-specific rewards from an alignment-oriented entity representation learning phrase. The method additionally includes providing selected entity pairs as augmented alignments to the representation learning phase.

According to yet other aspects of the present invention, a computer processing system is provided for cross-lingual knowledge graph alignment. The computer processing system includes a memory device for storing program code. The computer processing system further includes a processor device operatively coupled to the memory device for running the program code to formulate a credible aligned entity pair selection problem for cross-lingual knowledge graph alignment as a Markov decision problem having a state space, an action space, a state transition probability and a reward function. The processor device further runs the program code to calculate a reward for a language entity selection policy responsive to the reward function. The processor device also runs the program code to perform credible aligned entity selection by optimizing task-specific rewards from an alignment-oriented entity representation learning phrase. The processor device additionally runs the program code to provide selected entity pairs as augmented alignments to the representation learning phase.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a high-level block diagram showing an exemplary architecture, in accordance with an embodiment of the present invention;

FIGS. 3-4 show an exemplary method for cross-lingual knowledge graph alignment, in accordance with an embodiment of the present invention;

FIG. 5 is a diagram showing an exemplary sub-KG, in accordance with an embodiment of the present invention; and

FIG. 6 is diagram showing an exemplary embedding with different alignments corresponding to the sub-graph of FIG. 5, in accordance with an embodiment of the present invention.

### DETAILED DESCRIPTION OF PREFERRED EMBODIMENTS

Embodiments of the present invention are directed to knowledge graph alignment with entity expansion policy network.

In accordance with various embodiments of the present invention, an Entity Expansion Policy Network (ExPN) is proposed, which is a reinforcement learning based approach for cross-lingual KG alignment by augmenting the prior entity alignment with credible entity pairs during the training from different KGs.

In an embodiment, ExPN first selects credible entity pairs as alignment augmentations. These selected credible entity pairs are then used as training data as an augmented training set in the KG alignment. ExPN then updates the entity embeddings in KGs based on the augmented training set.

Specifically, in an embodiment, ExPN includes two phases, namely a credible aligned entity pairs selection phase and an alignment-oriented entity representation learning phase.

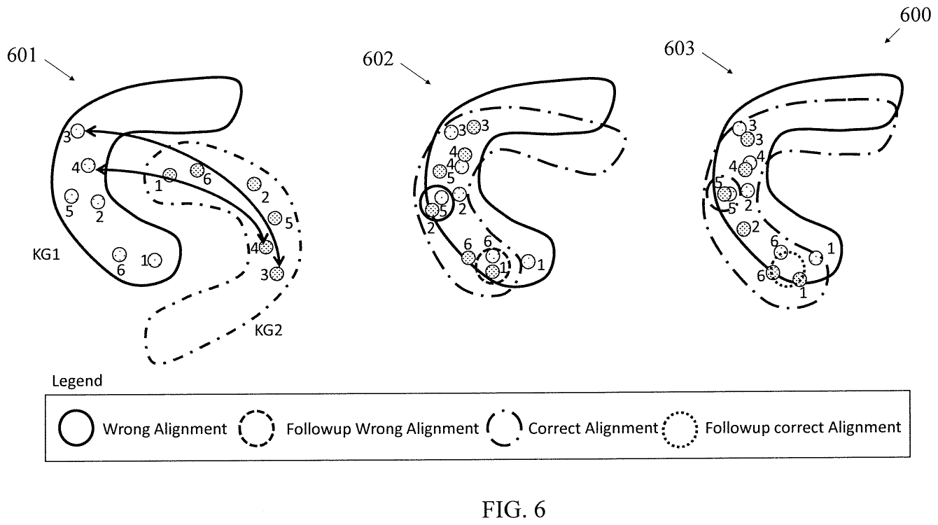

In the credible aligned entity pairs selection phase, ExPN formulates this selection problem as a Markov decision process (MDP) and learning a selection policy with the rewards calculated with entity embeddings from the alignment-oriented entity representation learning phase, as shown and described with respect to FIG. 6 herein below. In the alignment-oriented entity representation learning phase, ExPN iteratively re-trains the model with the augmented aligned entities as input from previous phase and provides the updated entity embeddings for the reward calculation.

In an embodiment, the present invention minimizes the cumulative alignment errors of the newly added alignments at each iteration, which is guaranteed by the selection policy of which minimizes the long-term reward in the credible aligned entity pair selection phase. These two phases are jointly trained to augment the aligned entity set with maximum cumulative rewards, and to learn alignment-oriented entity representations/embeddings. Note that ExPN is naturally an inductive model which can leverage both KG structures and the associated entity feature information to efficiently generate representations for unseen entities.

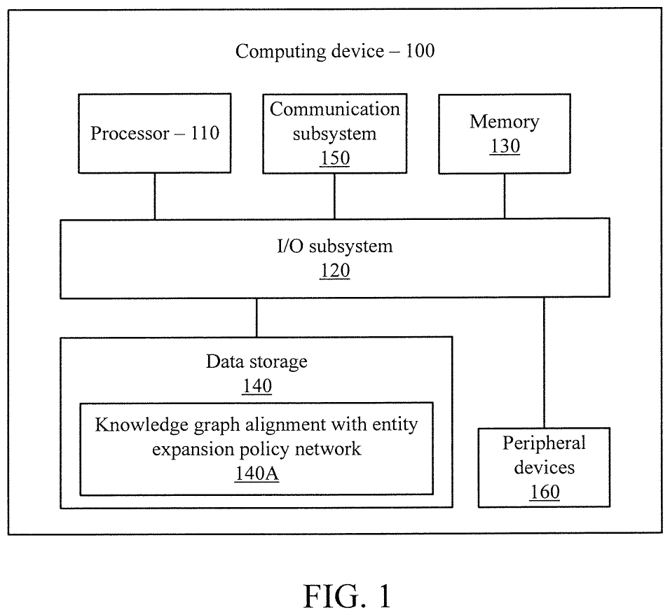

FIG. 1 is a block diagram showing an exemplary computing device 100, in accordance with an embodiment of the present invention. The computing device 100 is configured to perform knowledge graph alignment with entity expansion policy network.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor- based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for knowledge graph alignment with entity expansion policy network. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

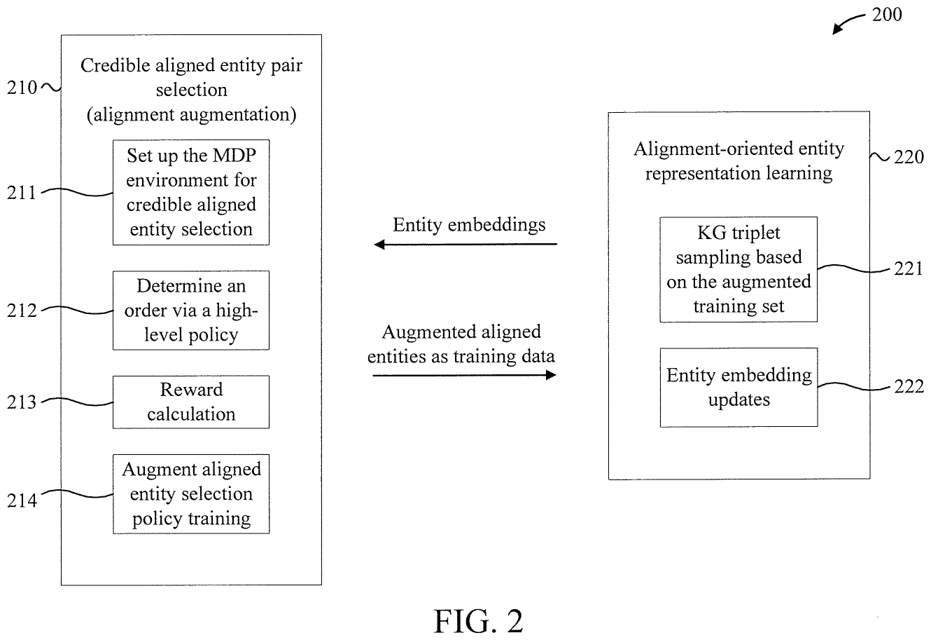

FIG. 2 is a high-level block diagram showing an exemplary architecture 200, in accordance with an embodiment of the present invention.

The architecture 200 includes a credible aligned entity pair selection (alignment augmentation) phase 210 and an alignment-oriented entity representation learning phase 220.

The credible aligned entity pair selection phase 210 can include one or more of blocks 211 through 214.

At block 211, set up the MDP environment for credible aligned entity selection.

At block 212, determine an order via a high-level policy.

At block 213, perform reward calculation.

At block 214, augment aligned entity selection policy training.

The alignment-oriented entity representation learning phase 220 can include one or more of blocks 221 through 222.

At block 221, perform KG triplet sampling based on the augmented training set.

At block 222, update the entity embeddings.

At block 230, entity embeddings are provided to the credible aligned entity pair selection phase 210 from the alignment-oriented entity representation learning phase 220.

At block 240, augmented aligned entities as training data are provided from the alignment-oriented entity representation learning phase 220 to the credible aligned entity pair selection phase.

The cross-lingual knowledge graph alignment problem is formulated as sequentially augmenting the train set of aligned entities with maximum cumulative reward signals and updating the entity embeddings based on the augmented alignment set with alignment-oriented entity representation learning.

A description will now be given regarding the credible aligned entity pair selection phase 210, in accordance with an embodiment of the present invention.

The augmented set of effective aligned entity pairs during training is formulated as a Markov decision process (MDP) including the normal state space, action space, state transition probability matrix (describe the transition probability of the state after taking an action), reward function and discount factor of an MDP. The goal is to learn a policy that maximizes the cumulative reward from cross-lingual KG alignment task.

A description will now be given regarding block 211, in accordance with an embodiment of the present invention.

In reinforcement learning, agent learns a policy via interacting with the environment. There is a natural environment in credible aligned entity pair selection task. There are four main components in this environment: state space, action space, state transition probability and reward.

State. The state sₜ encodes the information from the entity from KG1 and the selected entity from KG2, which is concatenation of the intermediate embeddings of the target entities from both KGs.

Action. The action aₜ={0,1} indicates whether the agent select t-th entity from the other KG as an effective alignment. For example, a₁=1 indicates u₁ is selected as a credible aligned entity, while a₂=0 means u₂ is not selected.

Reward. Our goal is to find an optimal set of credible aligned entity pairs to learn alignment-oriented knowledge graph embedding. The alignment accuracy scores can be used as the reward signal for the credible aligned entity pairs selection phase.

A description will now be given regarding block 212, in accordance with an embodiment of the present invention.

As aforementioned, chain rule is used to decompose the credible aligned entity pair selection as a sequential decision-making process. However, it requires an order to make decisions. Here, a high-level policy is designed to learn an order for the policy to take action.

A regret score l is defined for each entity in KGs to help determine the order. A neighbor with large regret score indicates it will be selected with higher probability. At each time step, the regret score of each entity is calculated and one of the entities is sampled to be the t-th alignment. The regret score is described as follows

lₜ=exp(W₁·ReLU(W₂·sₜ))

To reduce the size of the neighborhood for computational efficiency, we add an ending entity uₑ to for early stopping purpose. When uₑ is sampled, the credible entity pair selection process stops. The Softmax function is used to normalize the regret scores, and sample one entity from the distribution generated by Softmax to be the t-th entity to be aligned.

A description will now be given regarding block 213, in accordance with an embodiment of the present invention.

Our goal is to find the credible aligned entity pairs at each time-step to help improve the cross-lingual KG alignment task. We use two factors to calculate the reward as follows.
(1) Minimizing the errors in entity alignment with the given prior alignments and augmented alignments. In this case, the policy π_{θ} is enforced to make few errors in predicting the existing alignments. Thus, the precision of selecting existing alignments is tried to be maximized which is defined as rₚ=TP/(TP+FP), where TP indicates the number of selected pairs in the prior alignments, and FP is the number of selected pairs that are not in prior alignments.
(2) Minimizing the KG triplet loss. After the selection policy π_{θ} adding the newly aligned pairs, we calculate the triple loss defined as follows,

$${r}_{l} = {\sum }_{\{ τ ∈ {T}^{+} \}} {[ f ( τ ) - {ϵ}_{1} ]}_{+} + {w}_{3} + {w}_{3} {\sum }_{\{ {τ}^{′} ∈ {T}^{-} \}} {[ {ϵ}_{2} - f ( {τ}^{′} ) ]}_{+}$$

where the score f(τ)=∥h+r−t∥₂², is the embedding similarity of a KG triplet which includes head entity h, tail entity t, and the relationship r between these two entities. T⁺ and T⁻ indicate the positive triplet samples and negative triplet samples. ϵ₁, ϵ₂ and w₃ are hyper-parameters. This function ensures the learned entity embeddings can keep the semantic meaning, that is the score f of positive triples is smaller than the negative triples.

We combine these two factors as our final reward function rₜ,

rₜ=w₁·rₚ+w₂·rₗ

The aforementioned reward function can directly evaluate the accuracy of the alignments selected by the proposed selection policy.

A description will now be given regarding block 214, in accordance with an embodiment of the present invention.

Given the defined entity selection order defined in block 212, an action is taken at time step t is to decide whether to select the t-th entity. We will make several steps of decisions to determine the credible aligned entity pairs. Our goal is to maximize the total reward of all the actions taken during these time steps. In this invention, a policy network is learned to take these actions and achieve this goal, which is described as:

π_{θ}(aₜ|sₜ)=σ(W₁·ReLU(W₂·sₜ))

aₜ˜π_{θ} ∈ {0,1}

where W₂ and W₃ are weight matrixes, and the action aₜ samples from a Bernoulli distribution whose parameter is determined by the output of the policy π_{θ}(aₜ|sₜ).

A description will now be given regarding the alignment-oriented entity representation learning phase 220, in accordance with an embodiment of the present invention.

At each iteration, ExPN updates the entity embeddings of the entities from both KGs with the augmented training set. It first samples the KG triplets based on the augmented alignments, and the updates the entity embedding based on the cross-lingual KG alignment task.

A description will now be given regarding block 221, in accordance with an embodiment of the present invention.

Given the augmented alignment set, we swap aligned entities in their triples between KGs to calibrate the embeddings. In this case we can generate more positive triplets for training. This entity swap method between KGs also makes the entity embedding training more stable. As for the negative triplet sampling, the sampling scope is limited to a group of candidates which are k-nearest neighbors in the embedding space of the corresponding entities.

A description will now be given regarding block 222, in accordance with an embodiment of the present invention.

With the sampled positive triples T⁺ and negative triplets T⁻, the entity embeddings (parameterized with Ω) are updated as follows,

$$Ω = arg {min}_{Ω} {J}_{triplet} + {J}_{likelihood}$$

where Jₜᵣᵢₚₗₑₜ=rₗ=Σ_{{τ∈T}_{⁺}_{}}[f(τ)−ϵ₁]₊+w₃Σ_{{τ′∈T}_{^{−}}_{}}[ϵ₂−f(τ′)]₊ is the triplet loss which minimizes the embedding distance between similar entity pairs (positive samples), while maximizing the embedding distance between dissimilar entity pairs (negative samples). J_{likelihood}=−Σ₍ₑ_{ᵢ}_{,e}_{ⱼ}₎ log p(eⱼ|eᵢ; Ω) guides choosing the optimal entity embeddings Ω that achieves the highest alignment likelihood with all entity pairs (eᵢ, eⱼ).

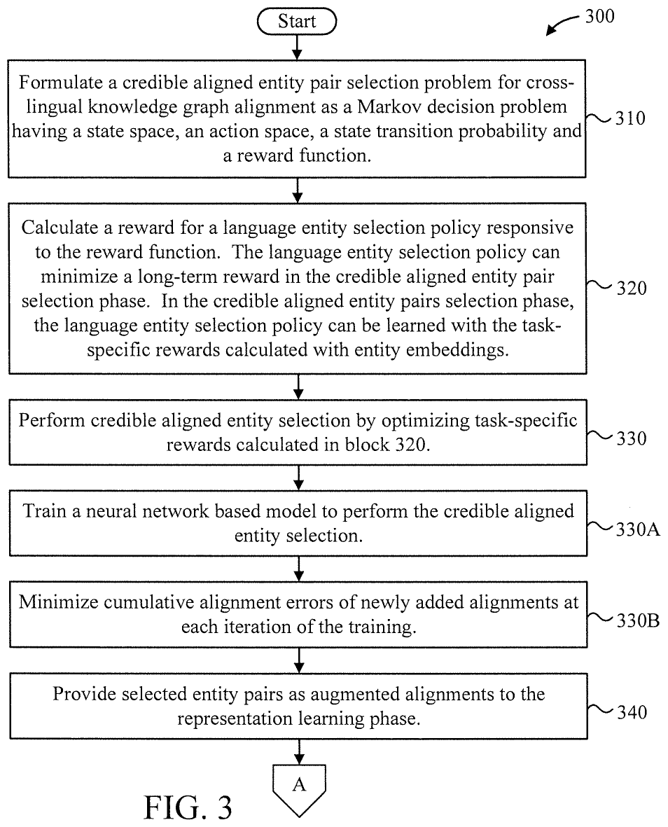

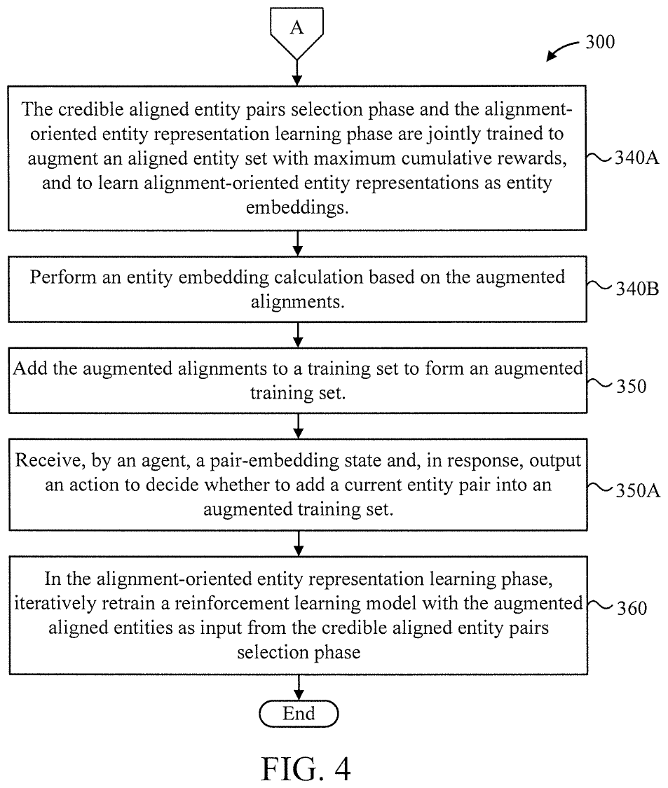

FIGS. 3-4 show an exemplary method 300 for cross-lingual knowledge graph alignment, in accordance with an embodiment of the present invention.

The method 300 is an inductive method leveraging both knowledge graph structures and associated entity feature information to efficiently generate representations for unseen language entities.

The method 300 includes a credible aligned entity pairs selection phase and an alignment-oriented entity representation learning phase. The credible aligned entity pairs selection phase includes blocks 310 through 330. The alignment-oriented entity representation learning phase includes blocks 340 through 350.

At block 310, formulate a credible aligned entity pair selection problem for cross-lingual knowledge graph alignment as a Markov decision problem having a state space, an action space, a state transition probability and a reward function.

At block 320, calculate a reward for a language entity selection policy responsive to the reward function. In an embodiment, the language entity selection policy can minimize a long-term reward in the credible aligned entity pair selection phase. In an embodiment, in the credible aligned entity pairs selection phase, the language entity selection policy can be learned with the task-specific rewards calculated with entity embeddings.

At block 330, perform credible aligned entity selection by optimizing task-specific rewards calculated in block 320.

In an embodiment, block 330 can include one or more of blocks 330A through 330B.

At block 330A, train a neural network based model to perform the credible aligned entity selection.

At block 330B, minimize cumulative alignment errors of newly added alignments at each iteration of the training.

At block 340, provide selected entity pairs as augmented alignments to the representation learning phase.

In an embodiment, block 340 can include one or more of blocks 340A through 340B.

At block 340A, the credible aligned entity pairs selection phase and the alignment-oriented entity representation learning phase are jointly trained to augment an aligned entity set with maximum cumulative rewards, and to learn alignment-oriented entity representations as entity embeddings.

At block 340B, perform an entity embedding calculation based on the augmented alignments.

At block 350, add the augmented alignments to a training set to form an augmented training set.

In an embodiment, block 350 can include bloc 350A.

At block 350A, receive, by an agent, a pair-embedding state and, in response, output an action to decide whether to add a current entity pair into an augmented training set.

At block 360, in the alignment-oriented entity representation learning phase, iteratively retrain a reinforcement learning model with the augmented aligned entities as input from the credible aligned entity pairs selection phase.

An action can be performed responsive to augmented aligned entities. The action can involve a translation from one language to another, where then an action such an opening a door, closing a door, unlocking an item (computer, door, window), and so forth. In this way, translation services can be provided by one or more embodiments of the present invention with an action performed subject to a given translation.

A description will now be given regarding a motivation of the present invention, in accordance with an embodiment of the present invention.

Limited labeled entities has shown to prevent the embedding-based approaches from learning accurate embeddings for entity alignment. Even though the bootstrapping method can be used to iteratively do data augmentation with learned alignment function, the mapping error will be accumulated along with the depth of augmentation. After certain iterations, no benefits will gain from data augmentation. Because the traditional iterative methods did not try to correct the alignments. Instead, the present invention corrects the new alignments via a reward signal

To solve the accumulated error, the data augmentation process is formulated as an MDP, where the cumulative rewards are considered to sequentially add the new alignments. Specifically, a meta-policy is used to guide to learn the embeddings.

A description of some of the many attendant benefits of the present invention include, but are not limited to:
(1) ExPN is first to learn a parameterized meta-learner to generate prior alignments for improve the alignment objective.
(2) To solve the compounding error of iteratively adding new alignments, a meta-learning approach is proposed where a meta-policy sequentially adds a set of most authentic entities to improve the embedding learner updating the embeddings.
(3) In addition, reinforcement learning is used to update the meta-learner with the goal of minimizing the cumulative alignment errors of adding the newly alignments at each time step, which can solve the compounding error problem.

A further description will now be given of a method, in accordance with an embodiment of the present invention.

The description will commence with a description of the problem formulation.

A knowledge graph G can be represented by the form of triple τ=(h, r, t), where head h, tail t ∈ E and relation r ∈ R. The bold-face letters h ∈ [symbol] ^{k}, r ∈ [symbol] ^{k}, and t ∈ [symbol] ^{k} respectively represent the embedding vectors of h, r, t. Given the entity sets E1 and E2 of the language-specific knowledge graph G1 and G2, the knowledge graph alignment asks to find A={(eᵢ, eⱼ) ∈ E₁×E₂|eᵢ≡ᵣeⱼ} where eᵢ≡ᵣeⱼ indicates an equivalence relation ≡ᵣ holds between eᵢ and eⱼ. The bold-face letters eᵢ ∈ R^{k}, eⱼ ∈ [symbol] ^{k} denote they are the embedding vectors of h, r, t. Usually a subset of already known alignments A′ are used as training data and the unknown alignments Ã are for testing. \tilde{E}₁ ∈ E₁ and \tilde{E}₂ ∈ E₂ denote the unaligned entities tried to be aligned.

Herein, one or more embodiments of the present invention may focus on learning a meta-policy π_{θ} to sequentially label a set of creditable entity alignments A⁻={(e⁻ᵢ, e⁻ⱼ) ∈ \tilde{E}₁×\tilde{E}₂} for prior alignments augmentation.

The objective function is described as follows:

$$\begin{matrix}{min}_{Ω , {π}_{θ}} - {\sum }_{( {e}_{i} , {e}_{j} ) ∈ A} log p ( {e}_{j} \vert {e}_{i} ; Ω ) & ( 1 ) \\ p = σ ( \frac{{e}_{i} \cdot {e}_{j}}{{‖ {e}_{i} ‖}_{2} {‖ {e}_{j} ‖}_{2}} ) & ( 2 )\end{matrix}$$

where Ω R^{N×k} represents the embeddings of G₁ and G₂ and N is the number of entities in G₁ and G₂. p is the probability of eᵢ aligned with eⱼ.

The labeling policy is allowed to select the unlabeled pairs to construct new training data.

To precisely find out the effective alignments, in an embodiment, the alignment generation problem is formulated as a sequential decision making problem, that is, the most authentic entitles are sequentially added for updating the embeddings. At each time step, only the most authentic alignments are added, which can disassemble the alignment error. In this regard, authenticity is determined by the highest cumulative rewards defined herein. In addition, the present invention can focus on minimizing the cumulative alignment errors of adding the newly alignments at each time step, which can solve the compounding error problem.

A description will now be given regarding alignments generation with meta-learning, in accordance with an embodiment of the present invention.

A parameterized meta-policy π_{θ} is learned to explicitly define the alignments generation function. The policy parameter θ is updated towards minimizing the expected cumulative alignment loss and translation loss calculated from Ω. The institution for updating π_{θ} is to find the effect that the change on would influence the embeddings Ω by changing the adding prior alignments. This technique can be viewed as an instance of meta learning. The meta-policy is served as a meta-learner that learns to improve the align objective.

Herein, the alignments generation procedure is modeled as a Finite Horizon Markov Decision Process. Reinforcement learning is leveraged for searching efficient policy π_{θ} to solve this MDP problem. The setting of the MDP framework is as follows:

State. For each time step, there are two embeddings that characterize the state sₜ:

sₜ=[eᵢ, eⱼ], eᵢ ∈ E₁, eⱼ ∈ E₂ (3)

which encodes the information from the i-th entity eᵢ and i-th entity eⱼ. Such features are essential for the policy to distinguish one pair of entities from another.

Action The policy π_{θ}(aₜ sₜ) maps the state sₜ into an action aₜ={0, 1} at each time step t, t=1, . . . , T. aₜ=1 indicates eᵢ and eⱼ is selected as an alignment pair, otherwise aₜ=0.

Reward. The goal is to find the efficient prior alignments at each time-step to help improve the alignment objective. Two factors are used to define the efficiency indicator.

Small errors in predicting the given prior alignments. In this case, the policy πθ is asked to make a few errors in predicting the existing alignments. Thus, the intention is to try to maximize the precision of selecting existing alignments:

$${r}_{p} = \frac{T P}{T P + F P} \qquad ( 4 )$$

where TP indicates the amount of selected pairs in the prior alignments, FP is the number of selected pairs not in prior alignments.

Small triple loss. After policy adding the newly alignments, the triple loss is attempted to be reduced as follows:

rₗ= [symbol] [f(τ)−ε₁]₊+w₃ [symbol] [ε₂−f(τ′)]₊ (5)

where the score f(τ)=∥h+r−t∥2/2, [symbol] and [symbol] indicate the positive samples and negative samples, Ε₁, Ε₁ and w₃ are hyper-parameters. This function tries to ensure the learned embeddings can keep the semantic meaning, that is the score f of positive triples is smaller than the negative triples.

These two loss functions are combined as the final reward function:

rₜ=w₁·rₚ+w₂·rₗ (6)

These two functions can directly evaluate the accuracy of the alignments selected by the policy. Note that the likelihood log p(eᵢ|eⱼ) is not considered as part of reward function, because with more added alignments it is easy to introduce the alignment error, which could cumulate through the training process.

Terminal. Once the similarity of the unlabeled pairs are all smaller than the pair similarity threshold in, the process stops. Given the above settings, a sample trajectory from this MDP will be: (s₁, a₁, r₁, . . . , s_{T}, a_{/T}, r_{T}). Since at each time-step, it is considered whether to add one pair of alignment causing high computation complexity, it is further considered adding K pairs of alignments at each time-step. After that, each pair is assigned an average reward.

Agents. The agent receives a pair-embedding state sₜ and then output the action aₜ to decide whether adding the current pair into the training dataset. After K pairs alignments added, the reward is evaluated on the validation set and return to the agent. The Deep Deterministic Policy Gradient (DDPG) model is used for learning policy, which is an off-policy actor-critic algorithm.

A description will now be given regarding meta-gradient of ExPN, in accordance with an embodiment of the present invention.

Herein, the embedding parameter is defined by Ω. As shown in Function 1, the nature of this function is determined by the meta-parameters θ. The algorithm starts with Ω, and update Ω with newly added alignments, resulting in new parameters Ω′; the gradient

$$\frac{d {Ω}^{′}}{d θ}$$

indicates that how the meta-parameters affected these Ω′.

A description will now be given regarding the objective, in accordance with an embodiment of the present invention.

By defining the reward function rₜ at each time step, which is parameterized by the alignment error and triple loss, a discounted reward is defined which considers cumulative reward or the expected return of the alignment process as follows:

Rₜ=Σₜ₌₀^{∞}γ^{l}(−rₜ₊ₗ) (7)

Now, the considered overall objective is defined as follows:

$$\begin{matrix}{max}_{θ , Ω} {J}^{al} ( θ ) = {𝔼}_{{s}_{1} , {α}_{1} , r - 1} , … , {s}_{T} , {a}_{T} , {r}_{T} [ {R}_{0} ] & ( 8 ) \\ s . t . Ω = arg {min}_{Ω} {J}^{triple} - {J}^{likelihood} & ( 9 ) \\ {J}^{triple} = {\sum }_{τ ∈ {\hat{𝒥}}^{+}} {[ f ( τ ) - {ɛ}_{1} ]}_{+} + & ( 10 ) \\ {w}_{3} {\sum }_{τ ∈ \hat{𝒥}} - {[ {ɛ}_{2} - f ( {τ}^{′} ) ]}_{+} & ( 11 ) \\ {J}^{likelihood} = {\sum }_{( {e}_{i} , {e}_{j} ) ∈ A} log p ( {e}_{j} \vert {e}_{i} ; Ω ) & ( 12 )\end{matrix}$$

where the objective depends on θ and Ω. The goal is to maximize J^{al} through optimizing θ, while the embedding parameter Ω is optimized by the triple loss and the likelihood. Equation 9 can be viewed as a bilevel optimization problem, since the problem of minimizing the triple loss is nested within the outer optimization task which is maximizing the expected return. The alignments are set with the same ID to promise achieving the maximum likelihood.

Algorithm. As a bilevel optimization problem, at each iteration, the policy parameters are updated with respect to the inner embedding, while the embedding parameters are updated to minimize the triple loss and maximize the likelihood.

Generating New Positive Triples via Prior Alignments

Specifically, given the prior alignments A′, first replace the entities in positive triples are replaced with their alignments in A′:

T^{al}={(eⱼ, r, t)|(eᵢ, r, t) ∈ T⁺} (13)

∪{(h, r, eⱼ)|(h, r, eᵢ) ∈ T⁺} (14)

∪{(eᵢ, r, t)|(eⱼ, r, t) ∈ T⁺} (15)

∪{(h, r, eᵢ)|(h, r, eⱼ) ∈ T⁺} (16)

Thus, new positive triples T⁺=T⁺∪T^{al} via A′ are generated.

Updating embeddings Ω With the positive triples T⁺, negative triples T⁻ and prior alignments A′, Ω are updated by the gradient as follows:

∀_{Ω}B log p(eⱼ|eᵢ; Ω)−(f(τ)₊− (17)

w₃·f(τ′)₊) (18)

Updating policy π_{θ} Then, the connection between Ω and θ is built, and the updating procedure for θ is specified. Given the updated embeddings Ω, the candidate alignments pairs with similarity large than threshold m are selected. In an embodiment, cosine similarity (eᵢeⱼ/∥eᵢ∥₂∥eⱼ∥₂) is used to measure the similarity of an entity pair (eᵢ, eⱼ). Given the candidate alignments, the policy parameters are updated by the DDPG model. With the trajectories generated by π_{θ}, θ can be updated by the policy gradient as follows:

∇_{θ} log π₀(aₜ|sₜ)Q_{θ}(sₜ, aₜ) (19)

After that, the new alignments whose aₜ equals 1 are added into A′. The updated A′ will used to update Ω.

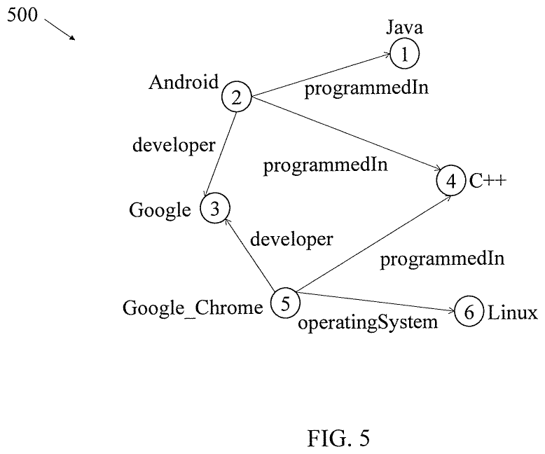

FIG. 5 is a diagram showing an exemplary sub-KG 500, in accordance with an embodiment of the present invention.

This is an exemplary sub-KG extracted from DBpedia. The nodes represent entities in different languages, e.g., persons, places and organizations. The edges represent the relationship between entities, e.g., “placeofbirth” and “programmedin”.

FIG. 6 is diagram showing an exemplary embedding 600 with different alignments 601 through 603 corresponding to sub-graph 500 of FIG. 5, in accordance with an embodiment of the present invention.

In alignment 602, a wrong alignment causes a follow-up error. In alignment 603, the error is corrected.

The shapes in solid line and dashed line represent the entity embedding space of KGs in two different languages, respectively. Circles 1-6 in different shapes represent the entities in the embedding space of different KGs. The goal is to align these entities with the same number in the two KGs. As can be seen from FIG. 5, both Android (entity 2) and Google Chrome (entity 5) are programmed in C++ (entity 4) and their developers are both from Google (entity 3), they have similar embedding at early iterations. If Android and Google Chrome are occasionally aligned, Java and Linux will be much closer in embedding space, leading to more errors. ExPN can help alleviate this issue by correcting the alignment of the entities Android and Google Chrome.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for cross-lingual knowledge graph alignment, comprising:
formulating a credible aligned entity pair selection problem for cross-lingual knowledge graph alignment as a Markov decision problem having a state space, an action space, a state transition probability and a reward function;
calculating a reward for a language entity selection policy responsive to the reward function;
performing credible aligned entity selection by optimizing task-specific rewards from an alignment-oriented entity representation learning phrase; and
providing selected entity pairs as augmented alignments to the representation learning phase.

2. The computer-implemented method of claim 1, further comprising adding the augmented alignments to a training set to form an augmented training set.

3. The computer-implemented method of claim 2, further comprising performing an entity embedding calculation based on the augmented alignments.

4. The computer-implemented method of claim 1, further comprising:
training a neural network based model to perform the credible aligned entity selection; and
minimizing cumulative alignment errors of newly added alignments at each iteration of the training.

5. The computer-implemented method of claim 4, wherein the language entity selection policy minimizes a long-term reward in the credible aligned entity pair selection phase.

6. The computer-implemented method of claim 1, wherein the method comprises a credible aligned entity pairs selection phase comprising the formulating and calculating steps, and the alignment-oriented entity representation learning phase comprising the performing and providing steps.

7. The computer-implemented method of claim 6, wherein the credible aligned entity pairs selection phase and the alignment-oriented entity representation learning phase are jointly trained to augment an aligned entity set with maximum cumulative rewards, and to learn alignment-oriented entity representations as entity embeddings.

8. The computer-implemented method of claim 6, wherein, in the credible aligned entity pairs selection phase, the language entity selection policy is learned with the task-specific rewards calculated with entity embeddings.

9. The computer-implemented method of claim 6, wherein, in the alignment-oriented entity representation learning phase, a reinforcement learning model is iteratively retrained with the augmented aligned entities as input from the credible aligned entity pairs selection phase, and wherein updated entity embeddings are provided for a reward calculation in the calculating step.

10. The computer-implemented method of claim 1, wherein the method is an inductive method leveraging both knowledge graph structures and associated entity feature information to efficiently generate representations for unseen language entities.

11. The computer-implemented method of claim 1, wherein an agent receives a pair-embedding state and, in response, outputs an action to decide whether to add a current entity pair into an augmented training set.

12. A computer program product for cross-lingual knowledge graph alignment, the computer program product comprising a non-transitory computer readable storage medium having program instructions embodied therewith, the program instructions executable by a computer to cause the computer to perform a method comprising:
formulating a credible aligned entity pair selection problem for cross-lingual knowledge graph alignment as a Markov decision problem having a state space, an action space, a state transition probability and a reward function;
calculating a reward for a language entity selection policy responsive to the reward function;
performing credible aligned entity selection by optimizing task-specific rewards from an alignment-oriented entity representation learning phrase; and
providing selected entity pairs as augmented alignments to the representation learning phase.

13. The computer program product of claim 12, further comprising adding the augmented alignments to a training set to form an augmented training set.

14. The computer program product of claim 13, further comprising performing an entity embedding calculation based on the augmented alignments.

15. The computer program product of claim 12, further comprising:
training a neural network based model to perform the credible aligned entity selection; and
minimizing cumulative alignment errors of newly added alignments at each iteration of the training.

16. The computer program product of claim 15, wherein the language entity selection policy minimizes a long-term reward in the credible aligned entity pair selection phase.

17. The computer program product of claim 12, wherein the method comprises a credible aligned entity pairs selection phase comprising the formulating and calculating steps, and the alignment-oriented entity representation learning phase comprising the performing and providing steps.

18. The computer program product of claim 17, wherein the credible aligned entity pairs selection phase and the alignment-oriented entity representation learning phase are jointly trained to augment an aligned entity set with maximum cumulative rewards, and to learn alignment-oriented entity representations as entity embeddings.

19. The computer program product of claim 17, wherein, in the credible aligned entity pairs selection phase, the language entity selection policy is learned with the task-specific rewards calculated with entity embeddings.

20. A computer processing system for cross-lingual knowledge graph alignment, comprising:
a memory device for storing program code; and
a processor device operatively coupled to the memory device for running the program code to
formulate a credible aligned entity pair selection problem for cross-lingual knowledge graph alignment as a Markov decision problem having a state space, an action space, a state transition probability and a reward function;
calculate a reward for a language entity selection policy responsive to the reward function;
perform credible aligned entity selection by optimizing task-specific rewards from an alignment-oriented entity representation learning phrase; and
provide selected entity pairs as augmented alignments to the representation learning phase.
